(19) United States
(12) Patent Application Publication
(10) Pub. No.: US 2011/0278236 A1
(43) Pub. Date: Nov. 17, 2011

(54) WATER TREATMENT DEVICE

(75) Inventor: David S. Matthews, Ballston Spa, NY (US)

(73) Assignee: Mr. David S. Matthews, Ballston Spa, NY (US)

(21) Appl. No.: 13/107,450

(22) Filed: May 13, 2011

Related U.S. Application Data
(60) Provisional application No. 61/334,395, filed on May 13, 2010.
(60) Provisional application No. 61/334,195, filed on May 13, 2010.

(51) Int. Cl. C02F 1/68; C02F 1/58; F16L 9/18

(52) U.S. Cl. 210/749; 138/114; 210/198.1

(57) ABSTRACT

In one embodiment, the invention provides a device including a first tubular member having a first diameter, the first tubular member including a first end having an attachment device for attaching the first tubular member to a fluid supply, a second end, and a perforated surface between the first end and the second end, and a second tubular member having a second diameter less than the first diameter, the second tubular member including, a first end, a second end, and a perforated surface between the first end and the second end, wherein the second tubular member is adapted to reside within the first tubular member.

### CROSS-REFERENCE TO RELATED APPLICATIONS

This application claims the benefit of co-pending U.S. Provisional Patent Application No. 61/334,195, filed 13 May 2010, which is hereby incorporated herein.

### BACKGROUND

Many water systems, such as sprinkler systems, fire hydrants, etc. employ water supplies that are treated with chlorine, potassium permanganate, or other chemicals commonly used to make the water supply potable, substantially free of particulates or color, etc. Proper maintenance of such systems requires that they periodically be flushed, during which a quantity of the water supply is discharged from the system through one or more outlets. The quantity so discharged can, depending on the size and type of system involved, be quite large.

Discharging large quantities of treated water into anything other than a dedicated receptacle, such as a storm drain system, necessarily involves discharging the chemicals contained within the water into the environment. This can have unintended consequences. For example, large quantities of chlorine or other chemicals discharged into a relatively small area may damage vegetation in the area or prove harmful to wildlife. In addition, directly discharging a large quantity of water without some mechanism of deflection may damage adjacent lawns, roadways, etc.

### SUMMARY

A first aspect of the invention provides a device comprising: a first tubular member having a first diameter, the first tubular member including: a first end having an attachment device for attaching the first tubular member to a fluid supply; a second end; and a perforated surface between the first end and the second end; and a second tubular member having a second diameter less than the first diameter, the second tubular member including: a first end; a second end; and a perforated surface between the first end and the second end, wherein the second tubular member is adapted to reside within the first tubular member.

A second aspect of the invention provides a dechlorinating system comprising: a dechlorinating composition; a first tubular member having a first diameter, the first tubular member including: a first end having an attachment device for attaching the first tubular member to a fluid supply; a second end; and a perforated surface between the first end and the second end; and a second tubular member having a second diameter less than the first diameter, the second tubular member including: a first end; a second end; and a perforated surface between the first end and the second end, wherein the second tubular member is adapted to reside within the first tubular member and contain the dechlorinating composition.

A third aspect of the invention provides a method of dechlorinating a quantity of water, the method comprising: inserting into a first tubular member having a first diameter a second tubular member having a diameter less than the first diameter, wherein each of the first tubular member and the second tubular member include a perforated surface; adding to the second tubular member a dechlorinating composition; connecting the first tubular member to a water supply; and passing a quantity of water from the water supply through the second tubular member and the first tubular member, whereby the dechlorinating composition within the second tubular member reduces a level of chlorine in the quantity of water.

### BRIEF DESCRIPTION OF THE DRAWINGS

These and other features of this invention will be more readily understood from the following detailed description of the various aspects of the invention, taken in conjunction with the accompanying drawings that depict various embodiments of the invention, in which:

FIG. 1 shows the disassembled components of a device according to one embodiment of the invention.

FIG. 2 shows the assembled device of FIG. 1 in use.

FIG. 3 shows the assembled device of FIG. 1 in use within a fire hose.

FIG. 4 shows a flow diagram of a method according to an embodiment of the invention.

It is noted that the drawings of the invention are not to scale. The drawings are intended to depict only typical aspects of the invention, and therefore should not be considered as limiting the scope of the invention. In the drawings, like numbering represents like elements among the drawings.

### DETAILED DESCRIPTION

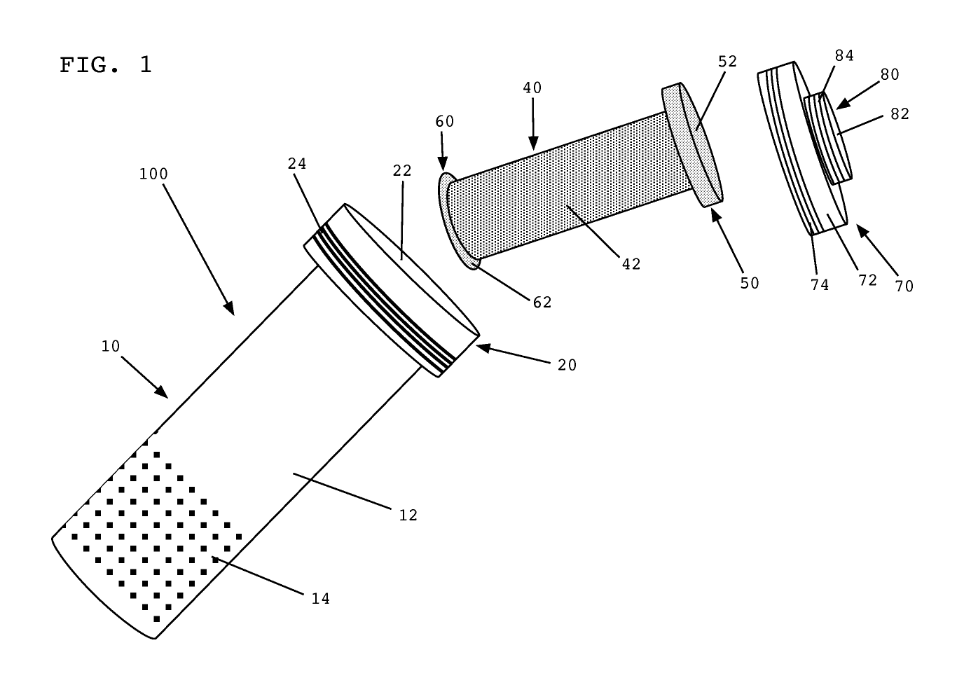

Turning now to the drawings, FIG. 1 shows a disassembled side view of a device 100 according to an embodiment of the invention. Device 100 includes a first tubular member 10 having a first end 20 and a second end 30. First tubular member 10 includes both a perforated surface 14 and a non-perforated surface 12.

First end 20 includes an opening 22 into which a second tubular member 40 may be placed, so as to substantially reside within first tubular member 10. Second end 30, in contrast, is closed in most embodiments of the invention. As will be explained in greater detail below, first end 20 may, in some embodiments, include an external attachment mechanism, such as threads 24, as shown in FIG. 1, to facilitate attachment of first tubular member 10 to a hose or similar device.

Materials suitable for use in first tubular member 10 include, for example, metals and metal alloys (e.g., steel, brass, aluminum, iron, brass), rigid plastics (e.g., polypropylene, nylons), and ceramics.

Second tubular member 40, as noted above, is adapted to pass through opening 22 and reside substantially within first tubular member 10. As such, second tubular member 40 has a diameter less than a diameter of first tubular member 10. Second tubular member 40 includes a body 42, at least a portion of which is perforated. In some embodiments of the invention, body 42 comprises a mesh material, such that all or substantially all of body 42 is perforated.

Second tubular member 40 further includes a first end 50 having an opening 52 and a second end 60 having a flange 62 or similar feature. When second tubular member 40 is fully inserted into first tubular member 10, flange 62 rests along second end 30 of first tubular member 10.

Materials suitable for use in second tubular member 40 include, for example, plastics (e.g., polypropylene, nylons), metal and/or metal alloy meshes (e.g., steel, copper, brass, aluminum), and ceramics.

Cap 70 includes a body 72 having an attachment mechanism, such as threads 74 along its exterior surface. Body 72 is adapted to reside within opening 22 of first tubular member 10 and be secured therein using threads 74. An interior surface of opening 22, in the embodiment of FIG. 1, would include threads (not shown) corresponding to threads 74 of body 72.

Cap 70 also includes an attachment device 80 for attaching cap 70 to a water supply, such as a spigot. Attachment device 80 includes external threads 84 for attachment to the water supply and an opening 82 through which water from the water supply may enter device 100. As should be apparent from FIG. 1, water entering opening 82 of cap 70 will pass through cap 70, into opening 52 of second tubular member 40, through body 42, into first tubular member 10, and exit device 100 through perforated surface 14 of first tubular member 10.

Materials suitable for use in cap 70 include, for example, plastics (e.g., polypropylene, nylons), metals and/or metal alloys (e.g., copper, aluminum, steel, brass, iron), and ceramics.

Body 42 of second tubular member 40 is adapted to contain granular or tableted compositions, which therefore contact and interact with water passing through device 100. Accordingly, de-chlorinating compositions or other compositions capable of treating water passing through device 100 may be added to second tubular member 40 before device 100 is connected to a water supply. Upon passing water through device 100, such compositions are capable of treating the water before it is discharged from device 100 into the environment.

Examples of compositions capable of treating water when used with device 100 include, for example, VITA-D-CHLOR granules and tablets, available from Integra Chemical. One gram of such compositions are capable of treating, for example, approximately 100 gallons of water containing 1 ppm chlorine. Accordingly, the dechlorinating compositions described in connection with the use of device 100 are understood to be capable of reducing a level of chlorine in a quantity of water passed through device 100.

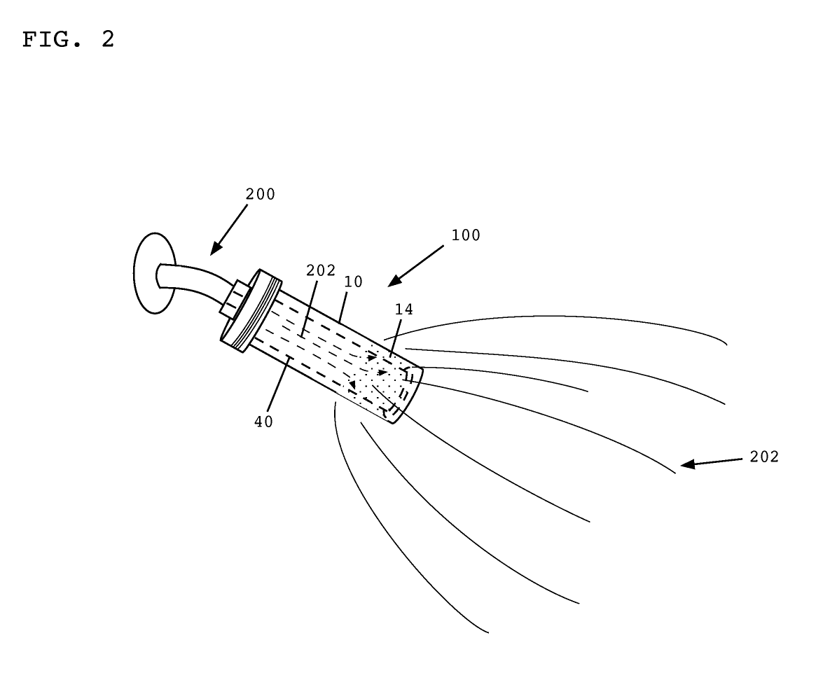

FIG. 2 shows assembled device 100 connected to a water supply 200, with a quantity of water 202 passing through device 100. Specifically, as described above, water 202 is shown being discharged through perforated surface 14 of first tubular member 10.

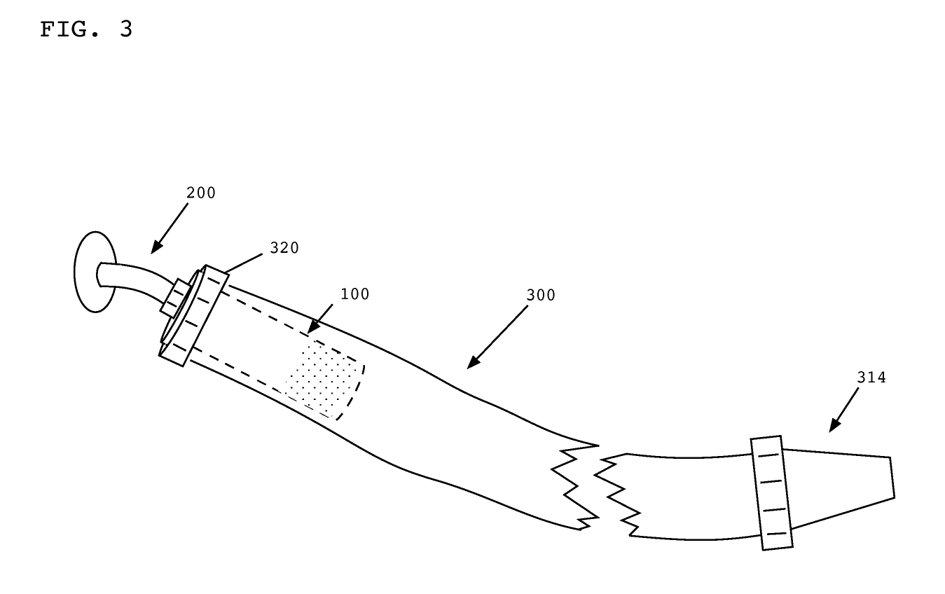

FIG. 3 shows an alternative embodiment, wherein the assembled device 100 lies within a fire hose 300 or similar structure, whereby water discharged through device 100 may be diverted to a more remote location, further minimizing damage to nearby vegetation, etc. As noted above, threads 24 (FIG. 1) on the first end 20 of first tubular member 10 permit attachment to a coupling 320 of fire hose 300. Although not shown in FIG. 3, one skilled in the art will understand that coupling 320 includes, on its inner surface, threads corresponding to threads 24, permitting attachment of fire hose 300 to device 100. Fire hose 300 may further include, for example, a nozzle 314 of similar feature for controlling flow of water discharged through device 100.

While device 100 is described above as useful in the removal of chemicals from water discharged through it, it should be noted that device 100 may also be employed in adding chemicals to such discharged water. For example, it may be the case that it would be desirable to add a chemical, such as a disinfectant or coloring agent, to the water passing through device 100.

Such a situation may arise, for example, where the water supply to which device 100 will be connected is non-potable or otherwise contaminated and it is unadvisable to discharge such contaminated water into the environment. In such a situation, a chemical agent, such as a decontaminating agent, may be added to second tubular member 40 (FIG. 1) in order to decontaminate water as it passes through device 100.

In other cases, it may be desirable to add a coloring agent, such as a dye, to water passing through device 100. Doing so may aid in confirming, for example, that a particular connection point to a water supply has been drained or flushed using device 100. In some cases, it may be desirable to add such a coloring agent to device 100 in addition to a compound for removing a chemical from the water and/or adding a chemical to the water.

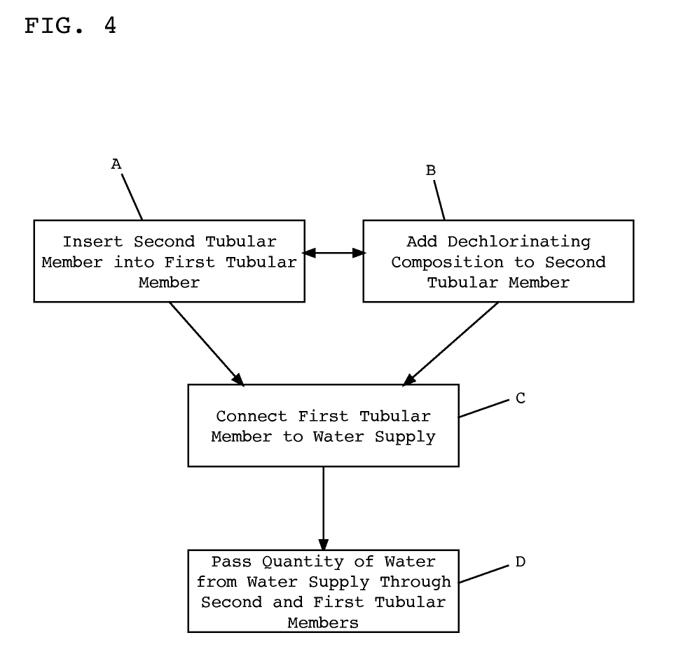

FIG. 4 shows a flow diagram of an illustrative method according to an embodiment of the invention. At A, the second tubular member 40 (FIG. 1) is inserted into the first tubular member 10. At B, a dechlorinating composition is added to the second tubular member 40. At C, the first tubular member 10 is connected to a water supply 200 (FIG. 2). As described above, such connection to the water supply 200 may be made, for example, using attachment device 80 of cap 70 (FIG. 1), which is then attached to first end 20 of first tubular member 10.

In the method depicted in FIG. 4, A and B may be performed in either order. For example, the dechlorinating composition may be added to the second tubular member 40, which is then inserted into the first tubular member 10. Alternatively, the second tubular member 40 may be inserted into the first tubular member 10 and the dechlorinating composition then added to the second tubular member 40.

In either case, the first tubular member 10 is then connected to the water supply at C. As noted above, this may be accomplished, for example, by attaching the first tubular member 10 to cap 70, which has already been connected to the water supply 200 using attachment device 80.

Finally, at D, a quantity of water is passed from the water supply 200 through the second tubular member 40 and first tubular member 10 and ultimately discharged from the device 100 through the perforated surface 14 of the first tubular member 10.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any related or incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A device comprising:
a first tubular member having a first diameter, the first tubular member including:
a first end having an attachment device for attaching the first tubular member to a fluid supply;
a second end; and
a perforated surface between the first end and
the second end; and
a second tubular member having a second diameter less than the first diameter, the second tubular member including:
a first end;
a second end; and
a perforated surface between the first end and
the second end,
wherein the second tubular member is adapted to reside within the first tubular member.

2. The device of claim 1, wherein the second tubular member is adapted to contain at least one of the following: a granular composition or a tableted composition.

3. The device of claim 2, wherein each of the granular composition and the tableted composition includes a dechlorinating composition.

4. The device of claim 2, wherein each of the granular composition and the tableted composition includes a coloring agent.

5. The device of claim 1, wherein the first end of the first tubular member further includes an external attachment mechanism for attaching the device within an additional device.

6. The device of claim 1, wherein the first tubular member further includes a non-perforated surface between the first end and the second end.

7. A dechlorinating system comprising:
a dechlorinating composition;
a first tubular member having a first diameter, the first tubular member including:
a first end having an attachment device for attaching the first tubular member to a fluid supply;
a second end; and
a perforated surface between the first end and
the second end; and
a second tubular member having a second diameter less than the first diameter, the second tubular member including:
a first end;
a second end; and
a perforated surface between the first end and
the second end,
wherein the second tubular member is adapted to reside within the first tubular member and contain the dechlorinating composition.

8. The dechlorinating system of claim 7, wherein the dechlorinating composition includes at least one of the following: a granular dechlorinating composition or a tableted dechlorinating composition.

9. The dechlorinating system of claim 7, wherein the first end of the first tubular member further includes an external attachment mechanism for attaching the device within an additional device.

10. The dechlorinating system of claim 7, wherein the first tubular member further includes a non-perforated surface between the first end and the second end.

11. A method of dechlorinating a quantity of water, the method comprising:
inserting into a first tubular member having a first diameter a second tubular member having a diameter less than the first diameter, wherein each of the first tubular member and the second tubular member include a perforated surface;
adding to the second tubular member a dechlorinating composition;
connecting the first tubular member to a water supply; and
passing a quantity of water from the water supply through the second tubular member and the first tubular member, whereby the dechlorinating composition within the second tubular member reduces a level of chlorine in the quantity of water.

12. The method of claim 11, wherein the dechlorinating composition includes at least one of the following: a granular dechlorinating composition or a tableted dechlorinating composition.

13. The method of claim 12, wherein passing the quantity of water from the water supply thorough the second tubular member and the first tubular member includes passing the quantity of water through the perforated surface of the second tubular member and the perforated surface of the first tubular member.
